(19) United States
(12) Patent Application Publication
(10) Pub. No.: US 2009/0090183 A1
(43) Pub. Date: Apr. 9, 2009

(54) Methods for compensating parameters of operating accelerometer for temperature variations

(75) Inventor: Ruey-Der Lou, Hsinchu City (TW)

Correspondence Address: BO-IN LIN, 13445 MANDOLI DRIVE, LOS ALTOS HILLS, CA, 94022, US

(73) Assignee: IMU

(21) Appl. No.: 12/287,243

(22) Filed: Oct. 6, 2008

Related U.S. Application Data
(60) Provisional application No. 60/997,975, filed on Oct. 5, 2007.

(51) Int. Cl. G01P 3/00; G01P 21/00

(52) U.S. Cl. 73/497; 73/1.37

(57) ABSTRACT

A method is disclosed in this invention for compensating a temperature dependent variation of an offset V_{offset} and sensitivity V_{sensitivity} parameters of an accelerometer. The method includes steps of a) Measuring a Sensitivity V_{sensitivity}(T0) and an Offset V_{offset}(T0) at a room temperature T0 to input to a microprocessor to calculate two tilt angles θ1 and θ2 in placing the accelerometer in a furnace for adjusting a controllable temperature therein; b) Keeping the accelerometer at the fixed tilt angle θ1 and adjusting the temperature of the furnace for measuring an output voltage at θ1 Vo(T, θ1) and keeping the accelerometer at another fixed tilt angle θ2 and adjusting the temperature of the furnace for measuring an output voltage at θ2 Vo(T, θ2); and c) solving equations to obtain the offset V_{offset} and sensitivity V_{sensitivity} parameters at different temperatures and storing these parameters in the microprocessor.

This Non-provisional Application claims a Priority Date of Oct. 5, 2007 benefited from a Provisional Patent Applications 60/997,975 filed by an Applicant as one of the Inventors of this Application. The disclosures made in Patent Application 60/997,975 are hereby incorporated by reference in this Application.

### BACKGROUND OF THE INVENTION

1. Field of the Invention

This invention relates generally to a method for calibrating and operating an accelerometer device. More particularly, this invention relates to methods of improving the methods of compensating parameters of operating accelerometers for temperature variation.

2. Description of the Prior Art

Conventional techniques for carrying out accelerometer measurements and calibrations caused by temperature variations still have technical difficulties and limitations. The accelerometers generally generate three types of output signals. The first type of output signal is an analog signal such as an output voltage. The second type of output signal is a digital pulse width modulation (PWM) signal. The PWM signal has time duration with a length that represent the duty cycle corresponding to the voltage of the analog signal. The third type of output signal is a sequence of binary digital pulse that represents the voltage of the analog signal. For the purpose of simplifying the explanations, the following discussions of calibration of accelerometers use examples of analog signals while the technical principles and descriptions are applicable to all three types of output signal.

An output voltage Vₒ is generated from an accelerometer when an acceleration represented by a parameter “a” is detected along the axes of the accelerometer. The acceleration “a” can be calculated from output voltage Vₒ and the gravity acceleration g as:

Acceleration a=g·{[Vₒ−V_{offset}]/V_{sensitivity}} (1)

There are two important accelerometer parameters, namely V_{offset} and V_{sensitivity} employed to compute the acceleration “a” according to Equation (1). The parameter V_{offset} representing an output voltage when there is no acceleration, i.e., when acceleration “a”=0. The parameter “g” in Equation (1) represents the gravity acceleration and in the following equations, Vg represents the voltage output when the acceleration value of the accelerometer has a value of “g”. As discussed above, the output signal from an accelerometer can also be a duty cycle of a pulse according to a pulse width modulation process for output signal generation or a pulse stream representing the voltage of the analog signal. In the above Equation (1):

V_{sensitivity}=V_{g}−V_{offset} (2)

Initially, a manufacturer of the accelerometer provides the values of these two parameters V_{offset} and V_{sensitivity} and the user of the accelerometer then applies the values of these two parameters and Equations (1) and (2) to measure and determine the accelerations according to the outputs. However, the values of these two parameters V_{offset} and V_{sensitivity} drift gradually and become inaccurate for acceleration computations. Inaccuracies of acceleration measurements are generated due to the value drifts of these two parameters due to variation of temperature changes in the surrounding environment for operating the accelerometer. More particularly, the general practice of the manufacturers now is to measure the values of V_{offset} and V_{sensitivity} of the accelerometer based on the output voltages of an accelerometer for a standard temperature of operation. The manufacturer may often provide a table for a user to adjust the values of V_{offset} and V_{sensitivity} of the accelerometer based on the temperature variations. However, the values may also drift and become inaccurate with the operation of the accelerometer. A user of the accelerometer is however unable to recalibrate the values of V_{offset} and V_{sensitivity} for adjusting the values caused by the changes of temperature. With such limitation, the user of an accelerometer has limited option but to continue to use an accelerometer with the built in values of the V_{offset} and V_{sensitivity} and their variations in different temperatures as these values continue to drift with time thus seriously affecting the accuracy and usefulness of the accelerometers.

Therefore, a need still exists in the art of accelerometer measurements, calibrations and operation to provide new and improved methods and processes to compensate for temperature variations in order to overcome the above-discussed difficulties and limitations.

### SUMMARY OF THE PRESENT INVENTION

Therefore, one aspect of this invention is to provide new and improved methods and device configurations for measuring and calibrating the values of V_{offset} and V_{sensitivity} and the variations of V_{offset} and V_{sensitivity} due to temperature changes such that the above-discussed problems and limitation encountered in the conventional accelerometers can be resolved.

Another aspect of this invention is to provide new and improved methods of measurements and calibration to measure and calibrate these operational parameters either with measurement and calibration equipment available in a manufacturer's factory or by using directly measurements of an accelerometer with a temperature sensor without such specific measurement and calibration equipment other than a furnace for controlling the operation temperatures.

In the descriptions of embodiments provided below, the accelerometers are described in applications for level measurements. However, the methods can be applied and suitable for different kind applications as well. The descriptions of the exemplary embodiments assume measurements of acceleration along one axis, but the same principles and methods would also be suitable and applicable for applications of acceleration measurement along axes for two or three dimensional acceleration measurements.

In an exemplary embodiment, this invention discloses a method for calibrating a temperature compensation for an accelerometer with an offset V_{offset} and sensitivity V_{sensitivity} implemented in a level gauge having a known value of an offset angle Δ. The method includes a step of placing the level gauge implemented with the accelerometer in a furnace to control a temperature variation and measuring an output voltage of the accelerometer at several tilt angles for calculating different values of V_{offset} and sensitivity V_{sensitivity} at different temperatures.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 shows a functional block diagram of an accelerometer for the level measurements implemented in this present invention for carrying out a calibration.

FIG. 2 is a diagram for illustrating that the component of the acceleration represented by a symbol “a” due to the gravity force when a surface is oriented with an angle relative to a horizontal level is a=g=sin θ.

### DETAILED DESCRIPTION OF THE PREFERRED EMBODIMENT

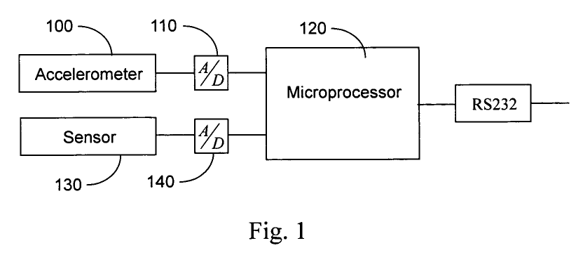

Referring to FIG. 1 for a functional block diagram showing the major functional blocks for a level gauge implemented with an accelerometer 100. The accelerometer 100 generates analog output signals for inputting to an analog to digital (A/D) converter 110 to generate digital signals. The digital signals are inputted into a microprocessor 120 connected to the user interface devices that may include a display device and a keyboard (not specifically shown). For the purpose of carrying out a temperature calibration, a temperature sensor 130 connected to another A/D converter 140 to generate digital signals to input to the microprocessor 120 are implemented with the microprocessor 120 connected to an device interface, e.g., an RS232 interface 150. The accelerometer 100 with the electronic devices as shown in FIG. 1 are supported on a printed circuit board (not specifically shown) and ready to carry out a temperature calibration according to a method disclosed in this invention. The microprocessor 120 receives periodically from the A/D converter 110 the output signals generated from the accelerometer 100. According to Equation (1) the acceleration “a” is represented as:

a=g·{[Vₒ−V_{offset}]/V_{sensitivity}}

When the axis of the accelerometer 100 is parallel to the bottom surface of the level gauge while the level gauge is tilted along an angle θ relative to the surface of the absolute horizontal level, the accelerometer detects the acceleration “a” as:

a=g·sin θ (3)

Therefore, sin=[Vₒ−V_{offset}]/V_{sensitivity} (4)

Or θ=sin⁻¹ {[Vₒ−V_{offset}]/V_{sensitivity}} (5)

The microprocessor 120 receives the output signal Vₒ is able to compute the tilt angle θ and display the value of the tilt angle θ on the LCD display 130. In these processes, the measurements are conducted under a temperature of 25° C. and the values of the offset V_{offset} and sensitivity V_{sensitivity} are calculated in this standard temperature.

Since the values of the offset V_{offset} and sensitivity V_{sensitivity} are changed with variations of temperature, the values of offset the V_{offset} V_{sensitivity} and sensitivity V_{sensitivity} at temperature “t” is represent by V_{offset} (t) and sensitivity V_{sensitivity} (t) for representing these values at a temperature of t° C.

To start the calibration process, the PC board supports the accelerometer and the circuit is placed into a furnace with a temperature controlled at t° C. and measuring an output voltage of Vₒ(θ₁, t) where θ₁ is the tilt angle of the PC board and θ₁ can be calculated as:

θ₁=sin⁻¹ {[Vₒ(θ₁, 25)−V_{offset}(25)]/V_{sensitivity}(25)} (6)

Keeping the tilt angle of the PC board unchanged while increasing the temperature of the furnace to 50° C., and measuring another output voltage from the accelerometer represented by Vₒ(θ₁, 50).

Vₒ(θ₁, 50)=V_{sensitivity}(50)·sin θ₁+V_{offset}(50) (7)

Turning down the temperature back to 25° C. then change the tilt angle of the PC board to θ₂ and measuring another output voltage from the accelerometer represented by Vₒ(θ2, 25).

θ₂=sin⁻¹ {[Vₒ(θ₂, 25)−V_{offset}(25)]/V_{sensitivity}(25)} (8)

Then, turning up the temperature back to 50° C. while keeping the tilt angle of the PC board at θ₂ and measuring another output voltage from the accelerometer represented by Vₒ(θ₂, 50).

Vₒ(θ₂, 50)=V_{sensitivity}(50)·sin θ₂+V_{offset}(50) (9)

The values of Vₒ(θ₁, 50), Vₒ(θ₂, 50) and θ₁, θ₂ are known, these equations can therefore be solved to calculated the values of V_{sensitivity}(50) and V_{offset}(50).

By repeating the above processes for different temperatures, the values of V_{sensitivity}(t) and V_{offset}(t) can be obtained for different values of “t”. By repeating this process for 100 temperatures between 0° C. ˜50° C., the values of V_{sensitivity}(t) and V_{offset}(t) can be generated for every 0.5° C. The values of V_{sensitivity}(t) and V_{offset}(t) can be stored in a microprocessor. The accelerometer may be operable between a temperature in a range of 0° C. ˜50° C., the values of V_{sensitivity}(t) and V_{offset}(t) can be conveniently generated by applying the data table generated by the above processes.

The above-described processes required many times of temperature adjustments and measurements and may become very time consuming and not practical. Another method may be implemented by starting the process of placing the PC board supporting the accelerometer into a furnace at a temperature of 0° C. keeping the tilt angle of the PC board to θ₁ with an unknown value of θ₁. The temperature of the furnace is gradually increased while the microprocessor continuously monitor and receiving digitized signals of voltage and temperature from the accelerometer and the temperature sensor as shown in FIG. 1. A calibration table can be established by calculating the value of θ₁ at a temperature of 25° C. and recording all the output values of voltage from the accelerometer represented by Vₒ(θ₁,t) where t may be for every small amount of temperature increase such as the voltage output of every 0.5° C. Then processes as described above may be repeated with another tilt angle θ₂. Therefore, the accelerometer may be operable between a temperature in a range of 0° C. ˜50° C., or another range of temperatures, with the values of V_{sensitivity}(t) and V_{offset}(t) can be conveniently generated by applying the data table generated by the above processes.

In summary, the processes involves the following several key steps:
(1) Measure the values of V_{sensitivity}(25) and V_{offset}(25) by placing the accelerometer supported on the PC board in a furnace at room temperature, e.g., a temperature of 25° C., and the microprocessor can calculate the tilt angles θ₁ or θ₂.
(2) Measure the output voltages when the PC board is placed in the furnace with a tilt angle of θ₁ and θ₂ by adjusting the temperature of the furnace within a range, e.g., 0° C. ˜50° C., for every 0.5° C. temperature increment.
(3) Applying the known values of θ₁, θ₂ and the corresponding voltages of Vo to calculate the V_{sensitivity} and V_{offset} by solving the equations as provided above.
(4) Store the values of V_{sensitivity} and V_{offset} at different temperatures in the microprocessor 120.
(5) The microprocessor can then applies the values of V_{sensitivity} and V_{offset} at different temperature to generate accurate output of measurements by applying calibrated values of V_{sensitivity} and V_{offset} stored in the microprocessor.

The range of temperatures and the incremental temperature of measurements can be flexibly selected other than the exemplary temperature range of 0° C. ˜50° C. and the incremental temperature of every 0.5° C. Furthermore, the exemplary application illustrates a single axis accelerometer, while the same temperature calibration process may be applied to accelerometer with two axes or three axes.

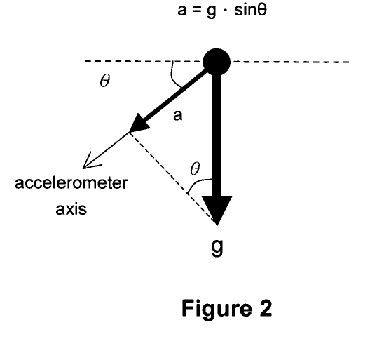

According to FIGS. 1 to 2 and the above descriptions, this invention discloses a method for compensating a temperature dependent variation of an offset V_{offset} and sensitivity V_{sensitivity} parameters of an accelerometer. The method includes steps of a) Measuring a Sensitivity V_{sensitivity}(TO) and an Offset V_{offset}(T0) at a room temperature T0 to input to a microprocessor to calculate two tilt angles θ1 and θ2 in placing the accelerometer in a furnace for adjusting a controllable temperature therein; b) Keeping the accelerometer at the fixed tilt angle θ1 and adjusting the temperature of the furnace for measuring an output voltage at θ1 Vo(T, θ1) and keeping the accelerometer at another fixed tilt angle θ2 and adjusting the temperature of the furnace for measuring an output voltage at θ2 Vo(T, θ2); and c) solving equations to obtain the offset V_{offset} and sensitivity V_{sensitivity} parameters at different temperatures and storing these parameters in the microprocessor. In an exemplary embodiment, the room temperature applied for measuring the Sensitivity V_{sensitivity}(T0) and an Offset V_{offset}(T0) is at a temperature T0=25° C. In another exemplary embodiment, the step of adjusting the temperature of the furnace is a step of adjusting the temperature of the furnace for measuring the output voltage at θ1 Vo(T, θ1) by increasing and decreasing the temperature every 0.5° C. between a range of 0° C. ˜50° C.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A method for compensating a temperature dependent variation of an offset V_{offset} and sensitivity V_{sensitivity} parameters of an accelerometer comprising:
measuring a Sensitivity V_{sensitivity}(T0) and an Offset V_{offset}(T0) at a room temperature T0 to input to a microprocessor to calculate two tilt angles θ1 and θ2 in placing the accelerometer in a furnace for adjusting a controllable temperature therein;
keeping the accelerometer at the fixed tilt angle θ1 and adjusting the temperature of said furnace for measuring an output voltage at θ1 Vo(T, θ1) and keeping the accelerometer at another fixed tilt angle θ2 and adjusting the temperature of said furnace for measuring an output voltage at θ2 Vo(T, θ2);
solving equations to obtain the offset V_{offset} and sensitivity V_{sensitivity} parameters at different temperatures and storing these parameters in the microprocessor.

2. The method of claim 1 wherein:
the room temperature applied for measuring the Sensitivity V_{sensitivity}(T0) and an Offset V_{offset}(T0) is at a temperature T0=25° C.

3. The method of claim 1 wherein:
the step of adjusting the temperature of the furnace is a step of adjusting the temperature of the furnace for measuring the output voltage at θ1 Vo(T, θ1) by increasing and decreasing the temperature every 0.5° C. between a range of 0° C. ˜50° C.

4. A method for calibrating a temperature compensation for an accelerometer with an offset V_{offset} and sensitivity V_{sensitivity} implemented in a level gauge having a known value of an offset angle θ_{Δ} a comprising:
placing the level gauge implemented with the accelerometer in a furnace to control a temperature variation and measuring an output voltage of the accelerometer at several tilt angles for calculating different values of V_{offset} and sensitivity V_{sensitivity} at different temperatures.
